(19) United States
(12) Patent Application Publication
(10) Pub. No.: US 2008/0076838 A1
(43) Pub. Date: Mar. 27, 2008

(54) METHODS OF PREPARING SILICA SOLS, AND STABLE HIGH-SOLIDS SILICA SOLS PREPARED THEREBY

(75) Inventor: Lothar Puppe, Burscheid (DE)

Correspondence Address: CONNOLLY BOVE LODGE & HUTZ, LLP, P O BOX 2207, WILMINGTON, DE, 19899, US

(73) Assignee: H.C. Starck GmbH, Goslar (DE)

(21) Appl. No.: 11/858,941

(22) Filed: Sep. 21, 2007

(30) Foreign Application Priority Data
Sep. 21, 2006 (DE) 10 2006 044 520.1

(51) Int. Cl. B01F 3/12

(52) U.S. Cl. 516/34

(57) ABSTRACT

Methods comprising: (a) providing a silica sol having a BET surface area of 15 to 1000 m²/g and a solids content of up to 45% by weight of silicon dioxide, based on the silica sol; (b) mixing the silica sol and an anionic polyether carboxylate to form a mixture, wherein the anionic polyether carboxylate is mixed with the silica sol in an amount of 0.01 to 10% by weight, based on the mixture; and (c) concentrating the mixture to form a concentrated mixture having a solids content of 20 to 70% by weight of silicon dioxide, based on the concentrated mixture; and the concentrated sols prepared thereby.

### BACKGROUND OF THE INVENTION

In general, silica sols are sedimentation-stable, colloidal solutions of amorphous SiO₂ in water, alcohols and/or other polar solvents. They generally have a viscosity similar to water, and some of the commercial products available can have relatively high solids concentrations depending on the SiO₂ particle size or BET surface area and can have stability against gelling. However, the solids concentration limits are highly dependent on the particle size of the SiO₂ particles in the sol. For example, a silica sol having a BET of about 500 m²/g and a particle diameter of 5 to 6 nm is commercially available as stable sol with up to only 15% by weight SiO₂, and a sol with 300 to 350 m²/g surface area and a particle diameter of 9 to 10 nm is marketed as a silica sol with up to only 30% by weight of SiO₂. Where BET surface areas of less than or equal to 200 m²/g and a mean particle size of >40 nm for the silica sol are used, is can be possible to establish solids contents of up to 40 and 50% by weight, depending on the particle size. Thus, the maximum solids content limit is between 35 and 40% by weight in the case of a silica sol having a particle size of about 12 nm (˜200 m²/g) and between 50 and 55% by weight in the case of a silica sol having a particle size of 80 to 100 nm. For example, a silica sol having a BET surface area of about 200 m²/g is not stable or cannot be prepared at all as a sol having a solids content of 50% by weight, since gelling occurs beforehand. A silica sol with 300 m²/g and 40% by weight solids content is likewise not sufficiently stable.

Particularly in the case of sots having small particles, however, it is desirable to achieve solids concentrations higher than 30% by weight of SiO₂, since the advantages of the small particles, such as high resistance to gelling when used as a binder and short reaction times in the sol-gel transformation, frequently cannot be utilized for different applications because the solids concentrations are not sufficient. Owing to the low solids concentrations, too much water is in the system and first has to be removed. This can lead to longer reaction times during setting as a binder or during the coating of substrates with the sol. Thus, for example, in the case of sol-gel applications, utilization of the high reactivity of silica sols with large specific surface areas and the high strength of the gels in order finally to obtain strong films which form from the sols with large surface areas could be advantageous. Accordingly, providing stable silica sols having a high solids content, preferably above the gel point, could be advantageous. Finely divided silica sols having large BET surface areas could be particularly advantageous.

Silica sols having high solids contents above the gel point have been mentioned in the literature, but the stability of such silica sols is not generally discussed. WO-A 99/01377 describes a complex process for the preparation of a finely divided silica sol having a high solids content, the concentration of which is achievable only via an ultrafiltration step and wherein the stability is improved by various partial ion exchange steps and partial alkalizations. The process described in WO-A 99/01377 has the disadvantage that it is too complicated for commercial applicability and cannot be used for the otherwise customary available particle diameter spectrum of silica sols. The silica sol described in WO-A 99/01377 moreover has a shelf-life of less than 6 months.

Polycarboxylates have been described, for example, in the form of a formulation for mouthwash mixtures which contains, as an additive, a polyether carboxylate, such as, for example, maleic anhydride/benzyl methyl ether copolymer, and inter alia a silica sol in addition to the customary constituents (cf. WO-A 94/00103). Furthermore, mortar compositions which contain as an additive, inter alia, also silica sols and polycarboxylates and/or sulphonated naphthalene/formaldehyde condensates are known (cf. for example WO-A 2001098227 and WO-A 2001090024). JP-A 11267585 describes a composition for a coating formulation which, in addition to the numerous different components, also contains silica sols and a polycarboxylate, such as, for example, glycidyl methacrylate/butyl methacrylate/methyl methacrylate/2-ethyl acrylate copolymer.

### BRIEF SUMMARY OF THE INVENTION

The invention relates, in general, to methods of preparing solids-rich silica sols by addition of polyether carboxylates, and silica sols which are obtainable by such processes. The present invention provides a simplified process for the preparation of silica sols having high solids contents and provides such stable silica sols having high solids contents.

Surprisingly, the inventors have found that the addition of small amounts of anionic polyether carboxylates permits the preparation of silica sols having higher solids contents. The stability of such silica sols having a high solids content can be substantially increased by the addition of the polyether carboxylates, and in various preferred embodiments even beyond the gel point thereof. It was also found that the properties, such as, for example, particle diameter, pH and BET surface area of the sol, do not change as a result of the addition of the anionic polyether carboxylates. Of course, the density and the viscosity increase according to the proportion of solids.

The present invention relates to a process for concentrating a silica sol, characterized in that

a silica sol having a BET surface area of 15 to 1000 m²/g and a solids content of up to 45% by weight of silicon dioxide, based on the total weight of the silica sol, is mixed with 0.01 to 10% by weight of one or more anionic polyether carboxylates, based on the total weight of the mixture, and

the mixture obtained is then concentrated to a solids content of 20 to 70% by weight of silicon dioxide, based on the total weight of the mixture.

One embodiment of the present invention includes methods comprising: (a) providing a silica sol having a BET surface area of 15 to 1000 m²/g and a solids content of up to 45% by weight of silicon dioxide, based on the silica sol; (b) mixing the silica sol and an anionic polyether carboxylate to form a mixture, wherein the anionic polyether carboxylate is mixed with the silica sol in an amount of 0.01 to 10% by weight, based on the mixture; and (c) concentrating the mixture to form a concentrated mixture having a solids content of 20 to 70% by weight of silicon dioxide, based on the concentrated mixture.

The concentration from up to 45% by weight to a solids content of 20 to 70% by weight is to be understood according to the methods of the present invention to mean that a higher solids content than before is achieved from a lower solids content in the silica sol used by concentration. In order to obtain a silica sol having a solids content of 20% by weight, it is accordingly necessary to start from a silica sol having a solids content of less than 20% by weight.

The anionic polyether carboxylate or carboxylates is or are mixed with the silica sol preferably in an amount of 0.05 to 10% by weight, particularly preferably in an amount of 0.1 to 2.0% by weight.

Another embodiment of the present invention includes concentrated mixtures prepared in accordance with any of the methods of the present invention. Other embodiments of the present invention include concentrated silica sol mixtures comprising 0.01 to 10% by weight of an anionic polyether carboxylate, based on a combined weight of the sol and carboxylate, wherein the solids content of the sol mixture exceeds the gel point and the sol mixture has a stability greater than 6 months.

### DETAILED DESCRIPTION OF THE INVENTION

As used herein, the singular terms “a” and “the” are synonymous and used interchangeably with “one or more” and “at least one,” unless the language and/or context clearly indicates otherwise. Accordingly, for example, reference to “an anionic polyether carboxylate” herein or in the appended claims can refer to a single anionic polyether carboxylate or more than one anionic polyether carboxylate. Additionally, all numerical values, unless otherwise specifically noted, are understood to be modified by the word “about.”

Suitable anionic polyether carboxylates include linear and/or branched polyether carboxylates. Suitable anionically charged polymers can be prepared, for example, by homo- or copolymerization of polycarboxylic acids or sulphonic acids and may contain charged or uncharged side chains of various types, such as, for example, alkyl chains, polyether groups and the like. Molecular weights of such suitable anionically charged polymers can be 1,000 to 2,000,000 g/mol, more preferably 5,000 to 30,000 g/mol.

Synthetic, branched anionic charged polyether carboxylates are preferred. Such preferred synthetic, branched anionic charged polyether carboxylates include compounds which comprise a charge-carrying polyether main chain having uncharged polyethylene side chains which side chains may vary—in number and chain length—and which may have molecular weights of 500 to 6,000 g/mol—based on the side chains and calculated from the total molecular weights. The main chain can be prepared, for example, by copolymerization of polyacrylic acids, maleic acids or polyols and vinyl ethers. The main chain, via carboxyl groups, bears negative charge which can be compensated by cations, such as, for example, sodium, potassium, calcium and/or ammonium. The molecular weights (weight average) can preferably range from 1000 to 50,000 g/mol—molecular weights of 5,000 to 30,000 g/mol are particularly preferred. Molecular weights can be determined, for example, by gel permeation chromatography. The gel permeation chromatography procedure is known to the person skilled in the art.

Suitable anionically charged polymers generally have a three-dimensional form, which can be characterized as a ratio of the polymer “diameter” to the length of the main chain. The “diameter” of the polyether carboxylate (dimension of the polyalkyl side chains) may be, for example, between 1.8 and 20 nm, and the length of the polyether main chain may be between 3 and 15 nm. The length of the main chain and the diameter of the polyether carboxylates with the side chains are determined by calculation assuming an angled chain. Suitable polyether carboxylates include those used as dispersants for inorganic pigments, such as titanium dioxide, transparent iron oxide or zinc oxide, and fillers. Such polyether carboxylates suitable in the context of the invention are mentioned, for example, in Table 1 below. They can be used in the form of aqueous solutions of 35 to 60% by weight as well as in the form of powders and can have different counter ions, such as K⁺, Na⁺, ammonium and/or Ca²⁺. With Na⁺ or K⁺ as the counter ion, they are particularly compatible with silica sols.

TABLE 1
Examples of suitable polyether carboxylates

| | | Diameter | | Total |
|---|---|---|---|---|
| | Length of the | of the | | molecular |
| | main chain | polymer | Opposite | weight |
| Product | [nm] | [nm] | ion | [g/mol] |
| Melpers ® 2450 | 6.3 | 12.8 | Na⁺ | 10 000 |
| Melpers ® 4100 | 11.9 | 25.2 | Ca²⁺ | |
| Melpers ® 0030 | 6.6 | 75.6 | Na⁺ | 20 000 |
| Melpers ® 1000 | 3.4 | 12.8 | Na⁺ | |
| Melpers ® 5344 | 12.4 | 6.8 | Na⁺ | |
| Melpers ® 5940 | 9.9 | 25.2 | Na⁺ | |
| Melpers ® VP1828 | | | Na⁺ | |

Such polyether carboxylates and the preparation thereof are known to the person skilled in the art (cf. for example, U.S. Pat. No. 5,739,212, the entire contents of which are incorporated herein by reference) and in some cases are also commercially available (cf. for example also products of SKW Polymers, GmbH, Trostberg, sold under the trade name Melpers®).

The mixing of the silica sol with the polyether carboxylate or carboxylates can be effected in any desired sequence of addition, and the mixing can be carried out in any manner suitable for blending the two components. It is possible on the one hand to add the polyether carboxylate or carboxylates to the silica sol and then to mix the two components, for example, by stirring. On the other hand, however, it is also possible initially to introduce the polyether carboxylate or carboxylates, optionally in the form of a solution, preferably in the form of an aqueous solution, and to add the silica sol and then to mix the two components, for example, by stirring. The combination and mixing can be carried out at various temperatures. Temperatures of 5° to 100° C. are preferred, particularly preferably temperatures of 15 to 50° C. can be used. The combination and mixing are very particularly preferably carried out at room temperature.

Suitable methods for concentrating the silica sol/polyether carboxylate mixtures according to the methods of the invention include, for example, thermal evaporation of this mixture to the desired SiO₂ concentration, or concentration with the aid of ultrafiltration, which can be more gentle. Such methods are known in principle to the person skilled in the art and are described, for example, in U.S. Pat. No. 5,458,812, the entire contents of which are incorporated herein by reference. Concentration by thermal evaporation can be carried out, for example, at temperatures of 20 to 100° C. It is possible to carry out concentration by thermal evaporation under reduced pressure or atmospheric pressure as well. Concentration by ultrafiltration can be carried out, for example, by passing the silica sol over a membrane (e.g., ceramic or polymer membrane), a part of the liquid phase passing through the membrane as permeate and the silica sol leaving the membrane as so-called retentate with a higher concentration of SiO₂. In order to achieve high flow-through rates, it is preferable to work at higher temperatures in the case of ceramic membranes since a lower viscosity of the silica sol then results.

Silica sols having a BET surface area of 15 to 1000 m²/g, preferably of 15 to 800 m²/g, particularly preferably of 50 to 700 m²/g, very particularly preferably of 100 to 600 m²/g, are preferably used for mixing with the anionically charged polyether carboxylates in the various embodiments of the present invention. The specific surface area can be determined either by the BET method (cf. S. Brunauer, P. H. Emmet and E. Teller, J. Am. Soc., 1938, 60, p. 309) on dried SiO₂ powder or directly in solution by titration according to G. W. Sears (cf. Analytical Chemistry, Vol. 28, page 1981, year 1956). Unless stated otherwise, values for the specific surface area which were determined by the BET method are stated in the present description.

The silicon dioxide particles of the silica sol used in the various embodiments of the present invention preferably have a mean particle diameter of 3 nm to 250 nm, particularly preferably of 5 to 150 nm and very particularly preferably of 9 to 120 nm. For the measurement of the particle diameter in the nanometer range, suitable methods are not only electron micrographs but also other different methods, such as, for example, laser correlation spectroscopy, photon correlation spectroscopy, ultrasound measurements or measurements using an ultracentrifuge (sedimentation). Owing to its sharp separation, the ultracentrifuge is particularly suitable for determining particle size distributions of nanoparticles. A special feature in the case of the ultracentrifuge is that fractionation of the dispersion according to particle size is effected prior to the actual measurement. In a homogeneous dispersion, the large particles are known to settle out more rapidly than the medium-sized and small particles also present. When a laser beam is projected through the ultracentrifuge cell, a substantially pronounced change in intensity occurs as a function of time. From the change of intensity, it is possible to calculate the change in concentration of the particles and from this the particle size distribution. The light source is an Ne—He laser. The ultracentrifuge permits a high accuracy, and a high resolution, and the distributions can be determined exactly. Measurements of the particle size distribution by means of an ultracentrifuge are therefore preferred in the context of the invention.

The silica sols used may have a pH of 1.5 to 12. They preferably have a pH of 2 to 12, particularly preferably between 8 and 11. At a pH above 12, peptization and dissolution of the particles with formation of alkali metal silicate solution can increasingly occur, and this is a reason why such pH values can tend to be disadvantageous. Unless otherwise characterized, the stated pH values are to be understood as meaning pH values which are determined at 25° C.

Silica sols having a solids content up to 45% by weight of silicon dioxide, preferably of 10 to 40% by weight of silicon dioxide, particularly preferably of 15 to 35% by weight of silicon dioxide, based on the total weight of the silica sol, are preferably used for mixing with the anionically charged polyether carboxylates in the various embodiments of the present invention.

The mixtures are preferably concentrated to a solids content of 35 to 65% by weight of silicon dioxide, preferably 40 to 60% by weight of silicon dioxide, based on the total weight of the mixture. Very particularly preferably, silica sol/polyether carboxylate mixtures which were concentrated beyond the gel point of the silica sol, i.e. have a solids content of silicon dioxide above the gel point of the silica sol) are obtained by the process according to the invention.

The gel point of a silica sol is to be understood in the context of the invention as meaning the solids content of silicon dioxide at which silica sols having silica sol particles of a certain particle size undergo irreversible gelling at a certain temperature. In the context of the invention, this is by definition the solids content of silicon dioxide at which a silica sol gels at 50° C. in the course of 6 months.

Silica sols can be prepared by condensation of monosilicic acids via a nucleation phase in a so-called growth process in which small SiO₂ particles grow on seeds present. The starting materials are molecular silicate solutions, freshly prepared dilute silicic acid solutions (so-called fresh sol), which contain particles smaller than 5 nm. More rarely, silica sol is obtained by peptization of silica gels or by other processes, for example dispersing of amorphous SiO₂ particles. The predominant part of the processes carried out on an industrial scale for the preparation of silica sols uses industrial waterglasses as starting material.

Soda waterglasses or potassium waterglasses are suitable for the process, soda waterglasses being preferred for cost reasons. Commercially available soda waterglass has a composition of Na₂O.3.34 SiO₂ and is preferably prepared by melting quartz sand with soda or a mixture of sodium sulphate and carbon, a transparent colorless glass, so-called lump glass, being obtained. This lump glass reacts in milled form with water at elevated temperature and pressure to give colloidal, strongly alkaline solutions, which are then also subjected to purification.

Processes in which finely divided quartz or other suitable SiO₂ raw materials are digested under hydrothermal conditions with alkalis directly to aqueous waterglasses are also known.

For the preparation of the silica sols used, an alkali-free SiO₂ solution which is produced by removing alkali metal cations from the waterglass is required. The most common method of dealkalization is the treatment of the dilute waterglass solutions with cation exchange resins in the H⁺ form. Suitable ion exchange resins are Lewatit® types from Lanxess AG. Preferably, waterglass solutions having a silicon dioxide content of less than 10% by weight are passed over exchange columns with acidic ion exchangers. Short residence times in the exchange zone, in which the pH of the solutions is 5 to 7, are important for avoiding gelling of the solutions and silicification of the exchange resin.

The resulting dilute silicic acid solution (the so-called fresh sol) is very unstable and is preferably stabilized and concentrated immediately by further alkalization and by growth on existing silica sol particles and by simultaneous, intermediate or subsequent thermal treatment. The concentration can be effected thermally by evaporation or by ultrafiltration over membranes. Ceramic membranes are suitable for this purpose. The silica sol is particularly preferably stabilized by rendering the solution alkaline to an SiO₂:Na₂O ratio of 60 to 130:1, heating a part of the solution to 60 to 100° C. for increasing the particle size, and then continuously adding the fresh sol solution and allowing growth on the existing particles. Concentration of the solution to the desired concentration can be carried out simultaneously or subsequently by evaporation. The finely divided silica sol (mean particle diameter usually less than 10 nm) rendered alkaline by means of inorganic bases has the disadvantage that the BET surface area does not remain stable. Such silica sols can therefore be stabilized with aluminum ions, for example (cf. K. K. Iler, The Chemistry of Silica, Wiley & Sons, New York, 1979, pages 407-410).

A detailed description of the properties, characterization and preparation of the silica sols is to be found in K. K. Iler, The Chemistry of Silica, Wiley & Sons, New York, 1979, pages 312 to 461.

Silica sols suitable for use in the process according to the invention are also commercially available with different solids contents below the gel point.

Surprisingly, the silica sol/polyether carboxylate mixtures prepared by the process according to the invention have a high stability. With the process according to the invention, it is possible to establish solids contents of the silica sol up to 70% by weight of SiO₂, depending on the particle size. These solids contents are in some cases already above the gel point which a concentrated silica sol of the same solids content of silicon dioxide would have without the polyether carboxylate addition.

Such stable silica sol/polyether carboxylate mixtures have not been described to date in the literature and are therefore likewise the subject of the present invention.

The silica sols according to the invention are suitable, for example, for use as binders in the lost-wax casting sector, in the adhesive sector, in the refractory sector, in the preparation of catalysts and for fibers, and furthermore for coatings for paper, in the clarification of beverages, in the textile sector as a non-slip finish, in the paper sector for non-slip finishes, in the building sector as additives for concrete, for gel batteries, as polishes for silicon wafers and in the production of thin layers for electronics as well as in paper retention.

The invention will now be described in further detail with reference to the following non-limiting examples.

### EXAMPLES

### Example 1

### Preparation of a Silica Sol/Polyether Carboxylate Mixture Having a BET Surface Area of 300 m²/g, an SiO₂ Content of 40% by Weight and a Mean Particle Diameter of 9 nm, in Accordance with an Embodiment of the Invention

999 g of silica sol 300/30% (i.e. having a BET surface area of 300 m²/g, an SiO₂ content of 30% by weight and a mean particle diameter of 9.2 nm) were initially introduced into a reaction flask, 1 g of Melpers® 2450 from SKW Trostberg (polyether carboxylate) was added and concentration to 40% by weight of SiO₂ was effected by boiling at 100° C.

| | |
|---|---|
| SiO₂ content: | 40% |
| Viscosity: | 13.3 mPa · s |
| Density: | 1.290 g/ml |
| Mean particle diameter: | 9.2 nm |

For determining the shelf-life, the silica sol is stored at 50° C. after cooling. After 8 months at 50° C., the silica sol still has not gelled.

### Comparative Example 1

### Preparation of a Silica Sol Having a BET Surface Area of 300 m²/g, an SiO₂ Content of 40% by Weight and a Mean Particle Diameter of 9 nm

1000 g of Levasil 300/30% were initially introduced into a reaction flask and concentrated to 40% by weight of SiO₂ by boiling at 100° C.

| | |
|---|---|
| SiO₂ content: | 40.1% |
| Viscosity: | 20 mPa · s |
| Density: | 1.292 g/ml |
| Mean particle diameter: | 9 nm |

For determining the shelf-life a part of the silica sol is stored at 50° C. after cooling. After 3.5 months at 50° C., the silica sol has gelled.

### Example 2

### Preparation of a Silica Sol/Polyether Carboxylate Mixture Having a BET Surface Area of 200 m²/g, a Mean Particle Diameter of 15 nm and an SiO₂ Content of 50% by Weight, in Accordance with an Embodiment of the Invention

999 g of silica sol 200/40% having a BET surface area of 200 m²/g and a mean particle diameter of 15.4 nm were initially introduced into a reaction flask, 1 g of Melpers® 2450 from SKW Trostberg polyether carboxylate) was added and concentration to 50% by weight of SiO₂ was effected by boiling at 100° C.,

| | |
|---|---|
| SiO₂ content: | 50.1% |
| Viscosity: | 72 mPa · s |
| Density: | 1.392 g/ml |
| Mean particle diameter: | 15.6 nm |

For determining the shelf-life, the silica sol is stored at 50° C. after cooling. After 6 months at 50° C., the silica sol is unchanged and still has not gelled.

### Comparative Example 2

### Preparation of a Silica Sol Having a BET Surface Area of 200 m²/g and an SiO₂ Content of 50% by Weight

1000 g of silica sol 200/40% were initially introduced into a reaction flask and an attempt was made to concentrate it to a solids content greater than 40% by weight of SiO₂ by boiling at 100° C. At a solids content of 46% by weight, the viscosity increases sharply and caking occurs. Further concentration is not possible.

### Example 3

### Preparation of a Silica Sol/Polyether Carboxylate Mixture Having a BET Surface Area of 300 m²/g, a Mean Particle Diameter of 9.3 nm and an SiO₂ Content of 40% by Weight, in Accordance with an Embodiment of the Invention

999 g of silica sol 300/30% were initially introduced into a reaction flask, 1 g of Melpers® 1828 from SKW Trostberg (polyether carboxylate) was added and concentration to 40% by weight of SiO₂ was effected by boiling at 100° C.

| | |
|---|---|
| SiO₂ content: | 40% |
| Viscosity: | 13.3 mPa · s |
| Density: | 1.290 g/ml |
| Mean particle diameter: | 9.2 nm |

For determining the shelf-life, a particle of the silica sol is stored at 50° C. after cooling. After 7 months at 50° C., the silica sol still has not gelled.

The examples clearly show that gelling of the silica sol/polyether carboxylate mixtures obtained can be prevented by the addition of the polyether carboxylates, although the silica sols without addition of polyether carboxylate and having the same BET surface area and the same SiO₂ content do gel, i.e. have solids contents above their gel point.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A method comprising: (a) providing a silica sol having a BET surface area of 15 to 1000 m²/g and a solids content of up to 45% by weight of silicon dioxide, based on the silica sol; (b) mixing the silica sol and an anionic polyether carboxylate to form a mixture, wherein the anionic polyether carboxylate is mixed with the silica sol in an amount of 0.01 to 10% by weight, based on the mixture; and (c) concentrating the mixture to form a concentrated mixture having a solids content of 20 to 70% by weight of silicon dioxide, based on the concentrated mixture.

2. The method according to claim 1, wherein the silica sol has a BET surface area of 15 to 800 m²/g.

3. The method according to claim 1, wherein the silica sol has a pH of 2 to 12.

4. The method according to claim 1, wherein the silica sol has a pH of 8 to 11.

5. The method according to claim 1, wherein the silica sol comprises silicon dioxide particles having a mean particle diameter of 3 nm to 250 nm.

6. The method according to claim 1, wherein the silica sol comprises silicon dioxide particles having a mean particle diameter of 9 nm to 120 nm.

7. The method according to claim 1, wherein the concentrated mixture has a solids content of 35 to 65% by weight.

8. The method according to claim 1, wherein the concentrated mixture has a solids content of 40 to 60% by weight.

9. The method according to claim 1, wherein the anionic polyether carboxylate is mixed with the silica sol in an amount of 0.05 to 10% by weight, based on the mixture.

10. The method according to claim 1, wherein concentrating the mixture comprises ultrafiltration.

11. The method according to claim 1, wherein concentrating the mixture comprises thermal evaporation.

12. A method comprising: (a) providing a silica sol having a BET surface area of 100 to 600 m²/g, wherein the silica sol comprises silicon dioxide particles having a mean particle diameter of 3 nm to 250 nm and a solids content of up to 45% by weight of silicon dioxide, based on the silica sol; (b) mixing the silica sol and an anionic polyether carboxylate to form a mixture, wherein the anionic polyether carboxylate is mixed with the silica sol in an amount of 0.05 to 10% by weight, based on the mixture; and (c) concentrating the mixture to form a concentrated mixture having a solids content of 40 to 60% by weight of silicon dioxide, based on the concentrated mixture.

13. A concentrated mixture prepared by the method according to claim 1.

14. A concentrated mixture prepared by the method according to claim 12.

15. A concentrated silica sol mixture comprising: (a) silicon dioxide particles having a mean particle diameter of 3 nm to 250 nm and having a BET surface area of 15 to 1000 m²/g; and (b) an anionic polyether carboxylate; wherein the concentrated silica sol mixture has a solids content of 20 to 70% by weight of silicon dioxide, based on the concentrated mixture.
